(19) United States
(12) Patent Application Publication
(10) Pub. No.: US 2008/0218793 A1
(43) Pub. Date: Sep. 11, 2008

(54) Client Device of Direct Printing System and Computer-Readable Recording Medium Containing Utility Program for Direct Printing

(75) Inventor: Kazuhiko SUGIURA, Hekinan (JP)

Correspondence Address: BANNER & WITCOFF, LTD.;ATTORNEYS FOR CLIENT NOS. 0166889, 006760, 1100 13th STREET, N.W., SUITE 1200, WASHINGTON, DC, 20005-4051, US

(73) Assignee: BROTHER KOGYO KABUSHIKI KAISHA, Nagoya (JP)

(21) Appl. No.: 12/042,456

(22) Filed: Mar. 5, 2008

(30) Foreign Application Priority Data
Mar. 6, 2007 (JP) 2007-056000

(51) Int. Cl. G06F 3/12

(52) U.S. Cl. 358/1.15

(57) ABSTRACT

A client device for a direct printing system includes the client device and a printing device connected to the client device, and an external device containing print data subject to direct printing being detachably connectable to either of the client device and printing device. The client device includes a judging unit configured to judge whether the external device is connected to the client device and a setting unit configured to set an output port of RAW format print data to the external storage connected to the client device if the judging unit judges that the storage device is connected to the client device.

### CROSS-REFERENCE TO RELATED APPLICATION

This application claims priority under 35 U.S.C. §119 from Japanese Patent Application No. 2007-056000 filed on Mar. 6, 2007. The entire subject matter of the application is incorporated herein by reference.

### BACKGROUND

1. Technical Field

The following description relates to a direct printing system and a computer-readable recording medium containing utility program for direct printing.

2. Related Art

Conventionally, there is known a direct printing system in which a printer directly reads print data stored in an external storage detachably connected to the printer, and print out the print data without necessitating data processing of a computer. An example of such a direct printing system is disclosed in Japanese Patent Provisional Publication No. 2005-216019 (hereinafter, referred to as '019 publication). According to '019 publication, a user installs a printer driver, which is preliminarily stored in an external storage such as a USB memory, in a computer, and then, makes a print instruction with the computer using the printer driver. That is, print data which can be read and printed out by the printer is stored in the external storage under control of the printer driver.

### SUMMARY

According to '019 publication, the printer driver is automatically configured to store EMF files (intermediate files) in the external storage, in which the installed printer driver was originally stored, based on identification information preliminarily stored in the external memory.

Therefore, when the direct printing system of '019 publication is used, in order to store the EMF file to an external storage other than the one in which the printer driver was originally stored, a user is required to designate a target external storage in which a file is stored manually at every printing operation, thereby making the file output operation for direct printing cumbersome.

In consideration of the above, the present invention is advantageous in that a simple output operation of print data is provided, with which the print data can be output to the desired external storage easily, even if the external storage is not one originally stored the printer driver.

According to aspects of the present invention, there is provided a client device for a direct printing system which including the client device and a printing device connected to the client device, an external device containing print data subject to direct printing being detachably connectable to either of the client device and printing device. The client device is provided with a judging unit configured to judge whether the external device is connected to the client device, and a setting unit configured to set an output port of RAW format print data to the external storage connected to the client device if the judging unit judges that the storage device is connected to the client device.

According to another aspect of the invention, there is provided a computer-readable recording medium containing a program to be executed by a computer, the program causing, when executed, the computer to functions as a client device for a direct printing system which including the client device and a printing device connected to the client device, an external device containing print data subject to direct printing being detachably connectable to either of the computer and printing device. The program includes the instructions of judging whether the external device is connected to the computer and setting an output port of RAW format print data to the external storage connected to the computer if the step of judging judges that the external storage is connected to the computer.

With the above configurations, the print data can be output to the desired external storage easily, even if the external storage is not one originally stored the printer driver.

### BRIEF DESCRIPTION OF THE ACCOMPANYING DRAWINGS

FIG. 1A schematically shows an example of a network system employing a direct printing system according to embodiments of the invention.

FIG. 1B is a block diagram showing a configuration of a client PC or a server PC of the network system shown in FIG. 1A.

FIG. 2 is a flowchart illustrating a printing process according to a first embodiment of the invention.

FIG. 3 shows an example of a confirmation screen displayed at the client PC.

FIG. 4 shows an example of the printer property screen displayed at the client PC.

FIG. 5 shows an example of a Media Port property window displayed at the client PC when a port configuration is selected on a printer property window.

FIG. 6 is a flowchart illustrating a printing process according to a second embodiment of the invention.

FIG. 7 is a flowchart illustrating a printing process according to a third embodiment of the invention.

FIG. 8 is a flowchart illustrating a printing process according to an embodiment of the invention.

### DETAILED DESCRIPTION

Hereinafter, referring to the accompanying drawings, direct printing systems according to embodiments of the invention will be described.

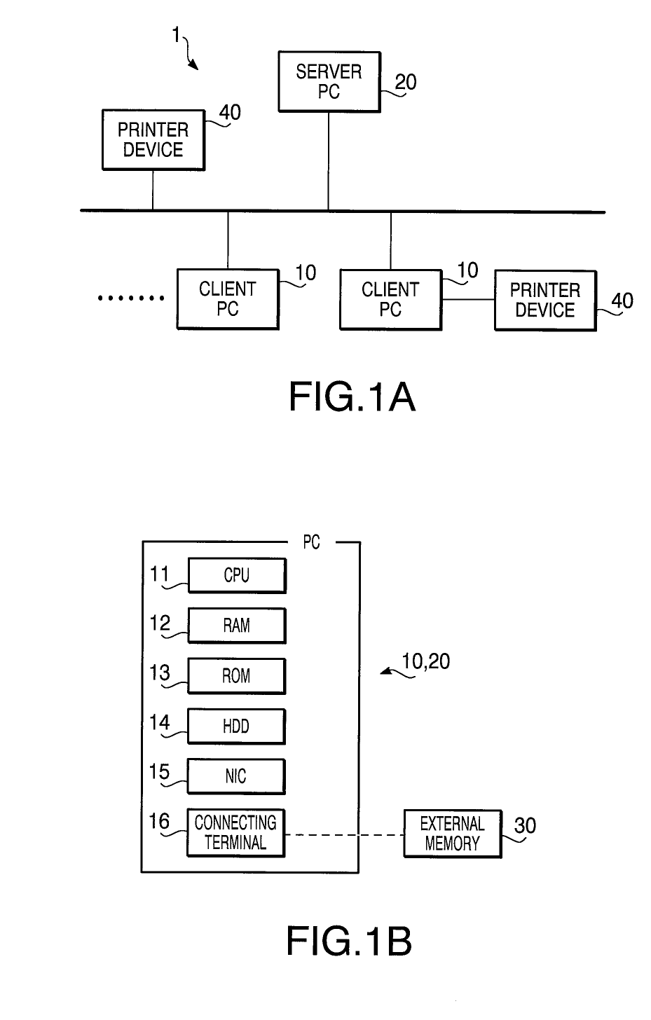

FIG. 1A schematically shows a network system 1 to which printing processes according to embodiments of the invention can be applied. As shown in FIG. 1A, the network system 1 is provided with a plurality of client PCs (Personal Computers) 10, a server PC 20 and a plurality of printing devices 40, which are interconnected via a network such as the Ethernet (Trade Mark). The server PC 20 is configured to provide the client PCs 10 with various services in response to requests from each of the client PCs 10.

FIG. 1B is a block diagram showing a hardware configuration of a client PC 10 according to embodiments of the invention. According to the embodiments, the hardware configuration of the client PC 10 and that of the server PC 20 are similar, and thus, only the configuration of the client PC 10 will be described and description on the configuration of the server PC 20 is omitted for brevity.

As shown in FIG. 1B, the client PC 10 is provided with a CPU 11, a RAM (Random Access Memory) 12, a ROM (Read Only Memory) 13, and a storage device such as an HDD (Hard Disk Drive) 14, a network interface such as an NIC (Network Interface Card) 15, and a connecting terminal 16.

According to the embodiments, an external storage 30 can be detachably connected to the connecting terminal 16. According to the embodiments, as the connecting terminal, a USB (Universal Serial Bus) terminal is employed. It should be noted that the invention need not be limited to the configuration of the embodiments, and other connecting terminals can be alternatively or optionally employed. The external storage 30 is a storage having an interface which can be connected to the connecting terminal 16. Typically, the external storage 30 may be a non-volatile storage device such as a USB (Universal Serial Bus) memory, an SD memory (Trade Mark), or an HDD device.

According to the embodiments, the server 20 mainly functions as a printer server. Specifically, the server PC 20 receives print requests (print instructions) from the client PCs 10, and temporarily stores print files (described later) in a predetermined area defined on the HDD 14. Then, based on the operational status of the printers 40, the server PC 20 transmits the print files to respective printers 40 so that the print requests from the client PCs 10 are appropriately dealt with.

A utility program for direct printing according to embodiments will be described in detail. The utility program is installed in the client PC 10, and then executed by the CPU 11 of the client PC 10. When the utility program is executed by the client PC 10, a printing process is executed which controls the direct printing operation (i.e., storing print files in the external storage 30) in association with functions of an OS (Operating System).

It should be noted that Windows (Trade Mark) operating system is used as the OS of the client PC 10 according to the embodiments. Therefore, terms referred to hereinafter without definition should be understood to have meanings generally used in the Windows operating system.

Further, the “direct printing” in the specification means an printing operation in which print data is directly dealt with by the printer 40 (i.e., printed by the printer 40) without requiring data processing of the PC 10. According the embodiments, the printer 40 is configured to read and print a so-called RAW format pint data files stored in the external storage 30 without requiring data processing by the PC 10. For executing the direct printing, the printer 40 is also provided with a connection terminal (not shown) to which the external storage 30.

The RAW format print data file is a data file in which print data is described using a language which the printer 40 uses, and thus the printer 40 can interpret the RAW format print data file directly.

For example, if the printer 40 is of an electro-photographic page printer configured to execute a printing operation on page-by-page basis, the print data may be of data using PDL (Page Description Language). If the printer 40 is a serial printer or line printer of an inkjet type printing mechanism, the print data may be described using languages capable of interpreted by respective printers 40.

According to the embodiments, the printers 40 can be connected to the client PCs 10 via the network or directly connected to a client PC 10 as shown in FIG. 1A.

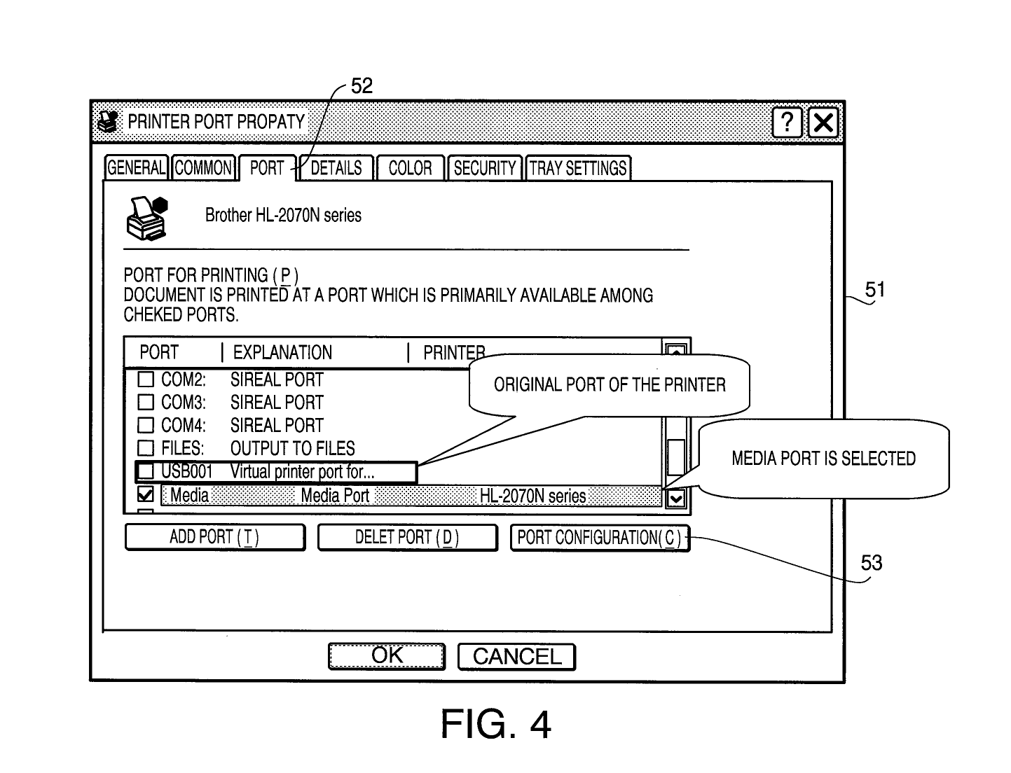

FIG. 4 shows an example of a printer property window 51 of the OS displayed on a display unit of the client PC 10. Specifically, FIG. 4 shows the printer property window 51 when a port tag 52 is selected. A user of the client PC 10 can set a port to be used for printing on the print property window 51 by checking a check box of the desired port.

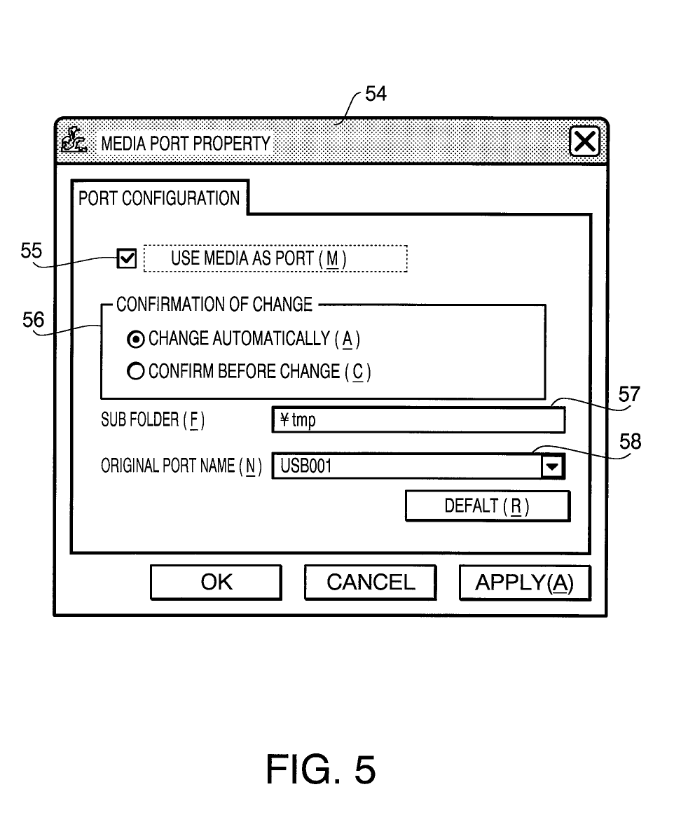

FIG. 5 shows an example of a Media Port property window 54 displayed on the client PC 10. The Media Port property window 54 is displayed when a check box 55 of “Media Port” is checked and a port configuration button 53 of the print property window 51 (see FIG. 4) is selected. The “Media Port” is a port driver (i.e., a virtual port generating program) which assigns a virtual port to the external storage 30 connected to the client PC 10. When the user decides to use the external storage 30 as a storage for storing a print data file for direct printing, the “Media Port” is selected, and the Media Port is used as an output port (which is a virtual port assigned by the virtual port generating program) to which the print data file is transmitted.

In the Media Port property window 54, the user can decide whether the external storage 30 is used as an output port of a print data file using the check box 55. Further, a selection section 56 of the Media Port property window 54 allows the user to select whether changing to the external storage 30 is done automatically or an approval by the user is required. When the user selects to make an approval before changing, a confirmation screen 50 shown in FIG. 3 is displayed to ask the user to determine whether the external storage 30 is used (i.e., Media Port is used) as the output port. The Media Port property window 54 is further provided with an input section 57 in which a folder name for outputting the print data file in the external storage 30 is input when the external storage 30 is used an output port, and an input section 58 which allows the user to input an original port to be used when the external storage 30 is not used as the output port. Normally, a port assigned to a printer, which is originally used, is input as the original port to the input section 58.

The printing device 40 is configured to read a print data file in RAW format (hereinafter referred to as “print file”) stored in the external storage 30 directly without requiring processing by the client PC 10. For this purpose, the printing device 40 is provided with a connecting terminal (not shown) to which the external storage 30 is detachably connected.

The print data file in RAW format includes print data generated by the client PC 10 with a language used in the printing device 40 so as to be interpreted by the printing device 40 without conversion. For example, print data in PDL (Page Description Language) format is included in the print file for an electrophotographic printing device capable of printing by pages. For a serial printing device or a line printing device, such as an ink jet printer, print data with a language interpretable to each printing devices is included in the print file.

Incidentally, in the present embodiment, the printing device 40 may be connected with the client PC 10 via the network or directly.

### First Embodiment

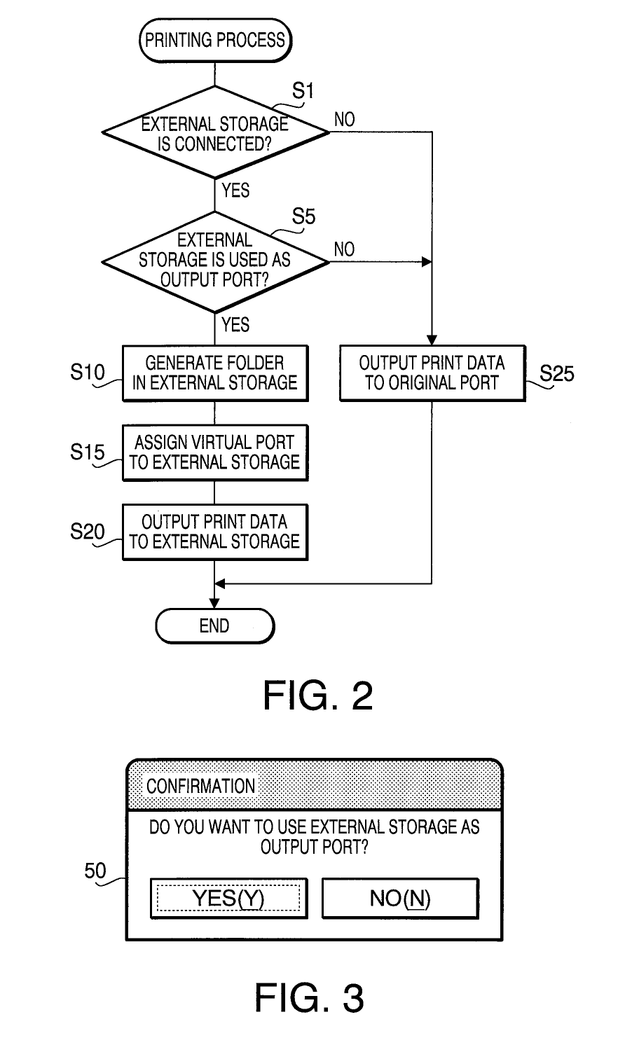

Hereinafter, the direct printing system according to a first embodiment of the invention will be described. FIG. 2 is a flowchart illustrating a printing process according to a first embodiment of the present invention. The printing process is executed by the CPU 11 of the client PC 10.

The printing process shown in FIG. 2 is started when a print instruction is made by a user of the client PC 10. When the printing process is started, the process judges whether the external storage 30 is connected to the client PC 10 (SI). Specifically, according to Windows system, the OS judges whether the external storage 30 is connected to the client PC 10. Therefore, in S1, whether a “removable disk” corresponding to the external device 30 is generated by the Explorer or in “My Computer” is judged to determine the external storage 30 is connected to the client PC 10.

When the process determines that the external storage 30 is connected to the client PC 10 (S1: YES), the process judges whether the external storage 30 is used as an output port (i.e., a destination port) for outputting the print file (S5). In other words, whether the Media Port is used or not is determined based on the user's selection (S5). That is, the process determines whether the check box 55 on the Media Port property window 54 is checked. When the check box 55 is checked, the process then determines whether the user selects to make an approval before changing in the selection section 56 on the Media Port property 54. When the user selects to make an approval, the confirmation screen 50 is displayed on the display unit of the client PC 10, which allows the user to determine whether to use the external storage 30 as an output port by selecting “YES” button or “NO” button on the confirmation screen 50. If the user selects “YES” button on the confirmation screen 50, or if the automatic change is selected in the selection section 56 on the Media Port property 54, the virtual port generating program is initiated, and the external storage 30 is set to the output port (S10-S20).

Specifically, when the external storage 30 is selected as the output port of the print file by the user (S5: YES), a predetermined folder is generated in the external storage 30 (S10). The predetermined folder is generated in accordance with information input in the input section 57 on the Media Port property window 54. If the predetermined folder already exists in the external storage 30, the step S10 is skipped.

Subsequently, a virtual port is assigned to the predetermined folder in the external storage 30 as the output port of the print file (S15). Incidentally, in the present embodiment, a name of the virtual port is determined such that a name of the print file is added after the name of the predetermined folder. Then, the print data is output to the virtual port, that is, the print file is stored in the predetermined folder in the external storage 30 (S20).

If the external storage 30 is not connected to the client PC 10 (S1: NO), or the external storage 30 is not selected as the output port (S5: NO), the print file is output to the original port input in the input section 58 of the Media Port property screen 54 (S25).

With the printing process according to the first embodiment as above, when the external storage 30 is connected to the connecting terminal 16 and the print instruction is made by the user, the external storage 30 connected to the connecting terminal 16 is set as the output port of the print file. Therefore, the output operation of the print file is simplified.

In the above embodiment, the virtual port is assigned to the external storage 30 connected to the connecting terminal 16 so as to set the external storage 30 as the output port of the print file. Therefore, the user can confirm the output port of the print file on a port monitor.

According to the above embodiment, the external storage 30 is not set as the output port of the print file when the external storage 30 is not connected to the connecting terminal 16. Therefore, an erroneous situation where the external storage 30 not connected to the connecting terminal 16 is set as the output port is prevented.

Further, according to the above embodiment, the user's intention is reflected to set the output port of the print file as the user is required to confirm whether the external storage 30 is used as the output port.

### Second Embodiment

Hereinafter, the direct printing system according to a second embodiment will be described. According to the first embodiment, the external storage 30 is principally set as the output port of the print file when a printing instruction is made by the user. According to a second embodiment, the external storage 30 is principally set as the output port of the print file when the external storage 30 is connected to the connecting terminal 16, regardless of whether the print instruction is made by the user.

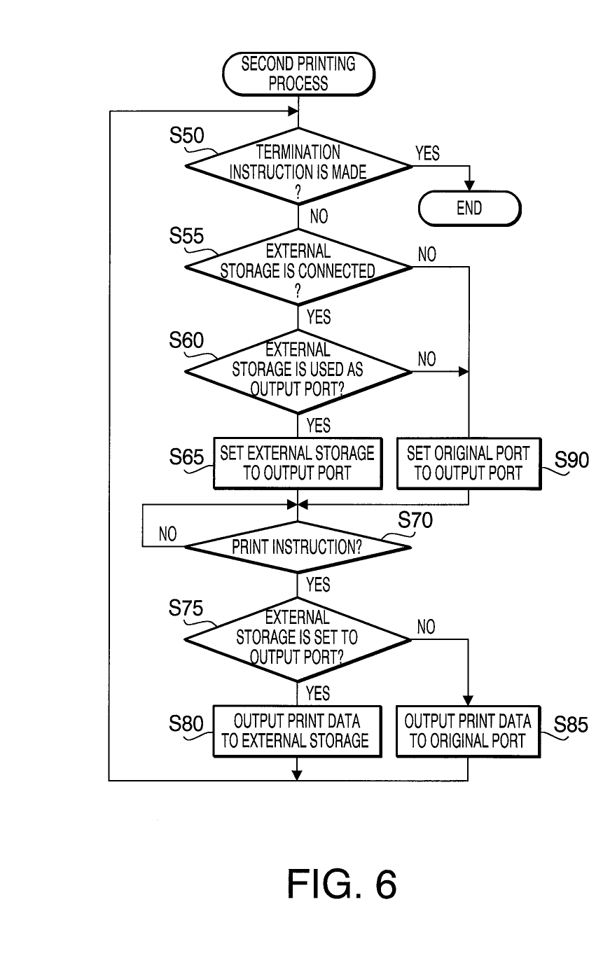

FIG. 6 is a flowchart illustrating a printing process executed by the client PC 10 according to the second embodiment. The printing process is started upon activation of the client PC 10 and repeated until a termination instruction is made by the user, or the client PC 10 is powered off.

When the printing process shown in FIG. 6 is started, the process judges whether the termination instruction is made by the user (S50). When the termination instruction is made by the user (S50: YES), the second printing process is terminated.

If the termination instruction is not made (S50: NO), the process judges whether the external storage 30 is connected to the connecting terminal 16 (S55). When the external storage 30 is connected to the connecting terminal 16 (S55: YES), the process determines whether the external storage 30 is to be used (i.e., the Media port is to be used) as the output port of the print file in accordance with a selection by the user as is determined in S5 (S60).

When the user selects to use the external storage 30 (i.e., the Media port) as the output port of the print file (S60: YES), a virtual port assigned to the external storage 30 is set to be used as the output port of the print file in a similar way as in S10 and S15 (S65). Then, the process judges whether the print instruction is made by the user (S70).

In S70, if the print instruction is not made by the user (S70: NO), the second printing process waits until the print instruction is made by the user. If the print instruction is made by the user (S70: YES), the process judges whether the output port of the print file is set to the virtual port assigned to the external storage 30 (S75).

If the output port of the print file is set to the virtual port assigned to the external storage 30 (S75: YES), the print file is output to the virtual port (S80), that is the print file is stored in the external storage 30.

If the process determines that the output port of the print file is not set to the virtual port assigned to the external storage 30 (S75: NO), the print file is output to a port (e.g., the original port as set to the output port in S90) other than the virtual port (S85).

Meanwhile, if the external storage 30 is not connected to the client PC 10 (S55: NO), or the external storage 30 is not determined to be used as the output port (S60: NO), the original port in the input section 58 is set to the output port (S90). Then the process goes to step S70.

With the printing process according to the second embodiment, when the external storage 30 is connected to the connecting terminal 16, the external storage 30 is principally set as the output port of the print file automatically, thereby simplifying the output operation of the print file.

### Third Embodiment

Hereinafter, the direct printing system according to a third embodiment of the invention will be described. In the first and second embodiments, when the external storage 30 is connected to the connecting terminal 16 and the print instruction is made by the user, the external storage 30 connected with the connecting terminal 16 is principally set as the output port of the print file regardless of how the printing device 40 is connected with the client PC 10 (e.g., connected via the network or directly). According to the third embodiment described hereinafter, only when the printing device 40 is connected with the client PC 10 via the network, the external storage 30 connected to the connecting terminal 16 is set as the output port of the print file.

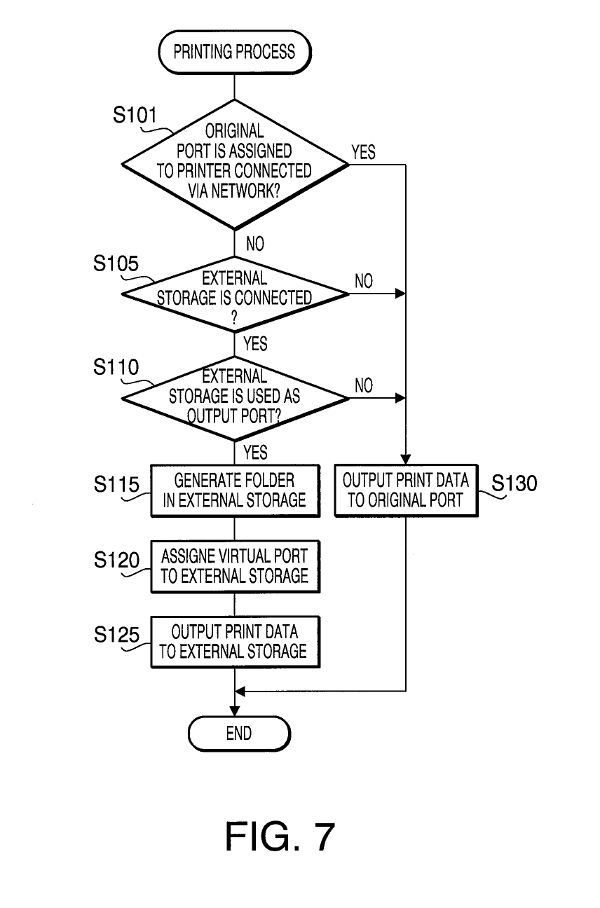

FIG. 7 is a flowchart illustrating a printing process executed by the client PC 10 according to the third embodiment. The printing process according to the third embodiment is started when the print instruction is made by the user of the client PC 10.

When the print instruction is made by the user, the process judges whether the original port input in the input section 58 of the Media Port property 54 is a port assigned to the printing device 40 connected via the network (S101).

When the original port is the port assigned to the printing device 40 connected via the network (S101: YES), the third printing process judges whether the external storage 30 is connected to the client PC 10 (S105).

If the external storage 30 is connected to the client PC 10 (S105: YES), the process determines whether the external storage 30 is used as the output port of the print file in accordance with a selection by the user in the same way as in S5 (S110). If the user selects to use the external storage 30 as the output port of the print file (S110: YES), a virtual port assigned to the external storage 30 is set to the output port of the print file, and the print file is output to the virtual port in a similar way as in S10-S20 in the first embodiment (S115-S125).

If the original port is not the port assigned to the printing device 40 connected via the network (S101: NO), if the external storage 30 is not connected to the client PC 10 (S105: NO), of if the external storage 30 is not determined to be used as the output port (S110: NO), the original port input in the input section 58 of the Media Port property screen 54 is set to the output port of the print file, and the print file is output to the original port (S130).

When the printing device is connected with the computer via the network, the printing device is generally located far from the computer used by the user. Therefore, because of the distance from the computer to the printing device, other person might unintentionally or erroneously take a printed document printed by the user of the computer, before the user goes to pick the printed document up from the printing device.

According to the third embodiment described as above, the external storage 30 is set as the output port of the print file when the printing device to which the original port is assigned is connected with the computer via the network, thereby allowing a user to perform the direct printing. According to the third embodiment, the document indicated in the print file is printed in front of the user, thereby preventing the printed document from taking away by the other person.

### Fourth Embodiment

Hereinafter, a fourth embodiment of the present invention will be described. According to the fourth embodiment, the external storage 30 is principally set as the output port of the print file when the printing device 40 is connected with the client PC 10 via the network as in the third embodiment.

According to the third embodiment, when the print instruction is made by the user, the external storage 30 is principally set to the output port. According to the fourth embodiment, the external storage 30 is set to the output port upon connection of the external storage 30 to the connecting terminal 16 regardless whether the print instruction is made.

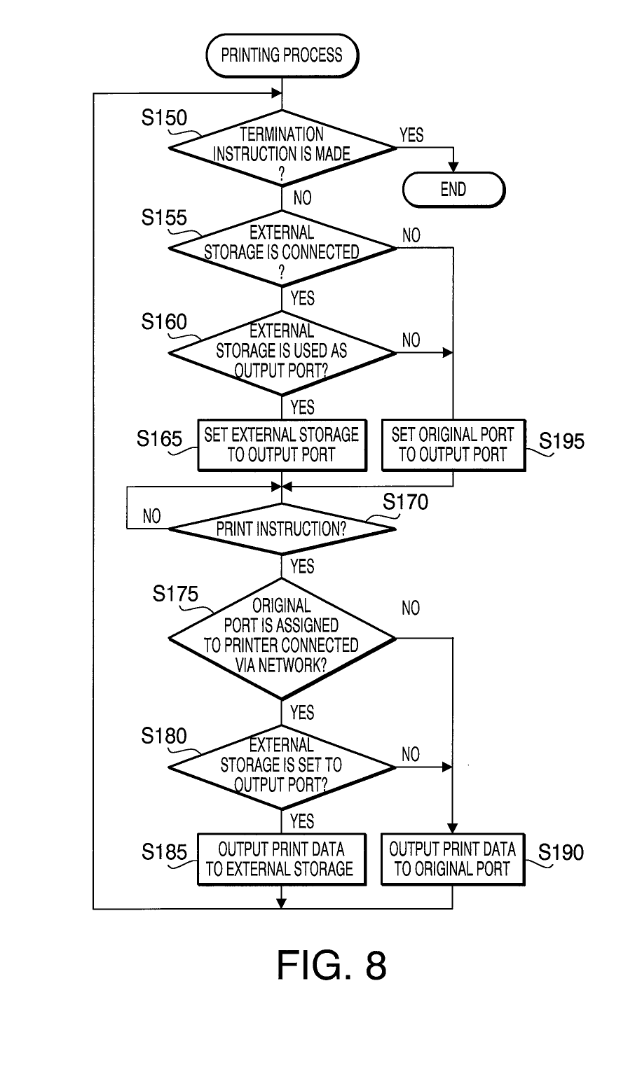

FIG. 8 is a flowchart illustrating a printing process executed by the client PC 10 according to the fourth embodiment. The printing process is started upon activation of the client PC 10 and repeated until a termination instruction is made by the user, or the client PC 10 is powered off.

When the printing process according to the fourth embodiment is started, the process judges whether the termination instruction is made by the user (S150). When the termination instruction is made by the user (S150: YES), the printing process is terminated.

If the termination instruction is not made by the user (S150: NO), the printing process judges whether the external storage 30 is connected to the connecting terminal 16 (S155). If the external storage 30 is connected to the connecting terminal 16 (S155: YES), the printing process judges whether the external storage 30 is used as the output port of the print file in accordance with a selection by the user (S160).

If the user selects to use the external storage 30 as the output port of the print file (S160: YES), a virtual port assigned to the external storage 30 is set to the output port of the print file (S165). Then, the process judges whether the print instruction is made by the user (S170).

If the external storage 30 is not connected with the client PC 10 (S155: NO), or the external storage 30 is not determined to be used as the output port (S160: NO), the original port input in the input section 58 of the Media Port property screen 54 is set to the output port of the print file (S195). Then the process goes to S170.

In S170, if the print instruction is not made by the user (S170: NO), the process waits until the print instruction is made by the user. If the print instruction is made by the user (S170: YES), the process judges whether the original port input in the input section 58 of the Media Port property 54 is a port assigned to the printing device 40 connected via the network as judged in S101 in the third embodiment (S175).

When the original port is the port assigned to the printing device 40 connected via the network (S175: YES), the process judges whether the output port of the print file is set to the virtual port assigned to the external storage 30 (S180). When the output port of the print file is set to the virtual port assigned to the external storage 30 (S180: YES), the print file is output to the virtual port (S185).

If the original port is not the port assigned to the printing device 40 connected via the network (S175: NO), or if the output port of the print file is not set to the virtual port assigned to the external storage 30 (S180: NO), the print file is output to the output port which is the original port input in the input section 58 (S190).

It will be appreciated that the present invention can be modified in various ways without departing from the scope of the invention. For example, while in the above embodiments, a virtual port is assigned to the external storage 30, the present invention is not limited to such configuration.

What is claimed is:

1. A client device for a direct printing system which including the client device and a printing device connected to the client device, an external device containing print data subject to direct printing being detachably connectable to either of the client device and printing device, comprising:
a judging unit configured to judge whether the external device is connected to the client device; and
a setting unit configured to set an output port of RAW format print data to the external storage connected to the client device if the judging unit judges that the external storage is connected to the client device.

2. The client device according to claim 1,
wherein the setting unit sets the output port of RAW format print data to the external storage connected to the client device when the external storage is connected to the client device and a print instruction is made by a user of the client.

3. The client device according to claim 1,
wherein the setting unit assigns a virtual output port to the external storage, and sets the virtual output port as an output port to be used for printing.

4. The client device according to claim 1,
wherein the setting unit excludes the external storage from a destination to which the RAW format print data file is transmitted when the external storage is disconnected from the client device.

5. The client device according to claim 1,
further comprising a selection unit which allows a user to determine whether the RAW format print data file is to be stored in the external storage connected to the client device.

6. The client device according to claim 1,
further comprising a second judging unit configured to judge whether the RAW format print data file is to be output to a printer which is indirectly connected to the client device via a network,
wherein the setting unit sets that the RAW format print data file is to be transmitted to the external storage if the second judging unit judges that the printer is connected to the client device via the network.

7. A computer-readable recording medium containing a program to be executed by a computer, the program causing, when executed, the computer to functions as a client device for a direct printing system which including the client device and a printing device connected to the client device, an external device containing print data subject to direct printing being detachably connectable to either of the computer and printing device,
wherein the program causing the computer to execute the steps of:
judging whether the external device is connected to the computer; and
setting an output port of RAW format print data to the external storage connected to the computer if the step of judging judges that the external storage is connected to the computer.

8. The recording medium according to claim 7,
wherein the step of setting sets the output port of RAW format print data to the external storage connected to the client device when the external storage is connected to the computer and a print instruction is made by a user of the client.

9. The recording medium according to claim 7,
wherein the step of setting assigns a virtual output port to the external storage, and sets the virtual output port as an output port to be used for printing.

10. The recording medium according to claim 7,
wherein the step of setting excludes the external storage from a destination to which the RAW format print data file is transmitted when the external storage is disconnected from the computer.

11. The recording medium according to claim 7,
wherein the program further includes the step of allowing a user to determine whether the RAW format print data file is to be stored in the external storage connected to the computer.

12. The recording medium according to claim 7,
wherein the program further includes a second judging step which judges whether the RAW format print data file is to be output to a printer which is indirectly connected to the computer via a network, and
wherein the step of setting sets that the RAW format print data file is to be transmitted to the external storage if the second judging step judges that the printer is connected to the computer via the network.
